(19) United States
(12) Patent Application Publication
(10) Pub. No.: US 2007/0032249 A1
(43) Pub. Date: Feb. 8, 2007

(54) Location services for and about mobile nodes

(76) Inventors: Govind Krishnamurthi, San Diego, CA (US); Margaret Livingston, Kirkland, WA (US)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 11/498,783

(22) Filed: Aug. 4, 2006

Related U.S. Application Data
(60) Provisional application No. 60/705,431, filed on Aug. 5, 2005.
(60) Provisional application No. 60/709,109, filed on Aug. 18, 2005.

(51) Int. Cl. H04Q 7/20

(52) U.S. Cl. 455/456.1

(57) ABSTRACT

IP-based Location Services (IP-LCS) is a valuable application that may be supported by a majority of cellular phones in the future. Services offered by such applications can be closely coupled to the location of the user. IP-LCS may be designed to permit a location based application resident on a mobile terminal to track a mobile terminal or a cluster of mobile terminals, or to otherwise provide location based services to a mobile node based on the location of another mobile node or a cluster of mobile nodes.

### CROSS REFERENCE TO RELATED APPLICATIONS

The present application is related to and claims the priority of U.S. Provisional Patent Application No. 60/705,431 filed Aug. 5, 2005, and U.S. Provisional Patent Application No. 60/709,109 filed Aug. 18, 2005, both of which are hereby incorporated by reference in their entirety.

### BACKGROUND OF THE INVENTION

1. Field of the Invention

IP-based LoCation Services (IP-LCS) is a valuable application that may be supported by a majority of cellular phones in the future. Services offered by such applications can be closely coupled to the location of the user.

2. Description of the Related Art

Currently, versions of IP-LCS are being standardized both in 3GPP2 (3rd Generation Partnership Project 2 IP-Based Location Services), as well as in OMA SUPL (Open Mobile Alliance Secure User Plane Location Architecture). The current, above-discussed specifications do not enable a mobile node to initiate a location based service (LBS) regarding another mobile node or cluster of mobile nodes.

Current specifications for IP-based location services include signaling to initiate LBS from a network based application or an application that resides in a mobile node to offer services based on the location of that mobile node. Such services could include providing a use of a mobile device that is pertinent to the user's location, as well as providing a user's location to emergency services if needed.

### SUMMARY OF THE INVENTION

One embodiment of the present invention is a method including identifying a first node and an entity. The method also includes serving the first node with a service based on a location of the entity. The method is implemented by a location based application residing on a the first node. The entity is configured to be a mobile entity.

Another embodiment of the present invention is a method including providing a request from a location based application to a mobile node. The method also includes forwarding, by the mobile node, the request to a location information platform. The method further includes identifying, by the location information platform, a second mobile node from the request. The method additionally includes identifying, by the location information platform, a second location information platform corresponding to the second mobile node. The method also includes contacting, by the location information platform, the second location information platform with the request. The method further includes obtaining, by the second location information platform location information of the second mobile node. The method additionally includes providing the location information to the location based application.

A further embodiment of the present invention is a method including receiving a request from a location based application of a mobile node for location information regarding a second mobile node. The method also includes identifying a resource for the location information. The method further includes obtaining the location information from the resource. The method additionally includes providing the location information to the location based application.

The present invention, in another embodiment, provides a device including a location based application resident on the device. The device also includes a transceiver configured to obtain a location of an entity to activate the location based application. The device is configured to be mobile. The entity is configured to be a mobile node or a cluster.

The present invention, in yet another embodiment, provides a system including a location based application configured to provide a request to a mobile terminal. The system also includes the mobile terminal configured to receive the request, and forward the request to an location information platform. The system further includes the location information platform configured to receive the request from the mobile terminal, to identify a second mobile terminal from the request, to identify a second location information platform corresponding to the second mobile node, and to contact the second location information platform with the request. The system additionally includes the second location information platform configured to receive the request, obtain location information of the second mobile node, and provide the location information to the location based application.

Another embodiment of the present invention is a device including a receiver unit configured to receive a request from a location based application of a mobile node for location information regarding a second mobile node. The device also includes an identification unit configured to identify a resource for the location information. The device further includes an obtainer unit configured to obtain the location information from the resource. The device additionally includes a provision unit configured to provide the location information to the location based application.

### BRIEF DESCRIPTION OF THE DRAWINGS

For proper understanding of the invention, reference should be made to the accompanying drawings, wherein:

FIG. 1 illustrates a system according an embodiment of the present invention;

FIG. 2 illustrates a signaling method according to an embodiment of the present invention;

FIG. 3 illustrates a method according to an embodiment of the present invention;

FIG. 4 illustrates another method according to an embodiment of the present invention;

FIG. 5 illustrates a further method according to an embodiment of the present invention;

FIG. 6 illustrates a mobile node according to an embodiment of the present invention;

FIG. 7 illustrates a system according to an embodiment of the present invention; and

FIG. 8 illustrates a location information platform according to an embodiment of the present invention.

### DETAILED DESCRIPTION OF THE PREFERRED EMBODIMENT(S)

Certain embodiments of the present invention can provide a way for a first mobile node to determine the location of a second mobile node. As will be discussed in more detail below, signaling can be specified for a mobile node (MN1) based application to initiate services based on the location of another mobile node (MN2). This may be valuable in gaming scenarios, where multi-player games offer services based on the location of the mobile nodes that are participating the gaming activity.

Certain embodiments of the present invention also have practical utility to use in tracking. One example of such tracking is the tracking the location of a pet or vehicle, where the pet or vehicle is equipped with a device that communicates with a network. Another example would be to track employees, coworkers, friends, or family members. Previously, mobile based applications for a host mobile node could use only the host mobile node's location information to provide services.

Other embodiments of the present invention have the utility of initiating services such as gaming services or tracking based on the location of a cluster (two or more nodes). Such embodiments may be useful for coordinating team efforts, such as construction projects, or for maintaining a visual inventory of fleet of vehicles, such a taxi-cab fleet.

Signaling that can enable provision of a location based application (LBA) residing on a mobile node to ascertain the location of another mobile node (or cluster) and to offer service to the initiating mobile node based on the location of the other mobile node (or cluster) is discussed below. Thus, location based applications, residing on a mobile node, may be able to provide services based on the locations of more than one mobile node or mobile nodes that that are members of a particular group.

The necessary signaling is presented for an application residing on a mobile node. The mobile node can request the location of another mobile node (or cluster) in order to provide location based services to the first mobile node.

The signaling discussed herein can be made using the nomenclature of nodes in an Open Mobile Alliance Secure User Plane Location (OMA SUPL) architecture, but are applicable to other architectures, such as any internet protocol (IP)-based location services architecture. The ideas presented herein may also be applicable to scenarios described in various versions of the third generation partnership project 2 (3GPP2) X.P.0024 IP-LCS specification.

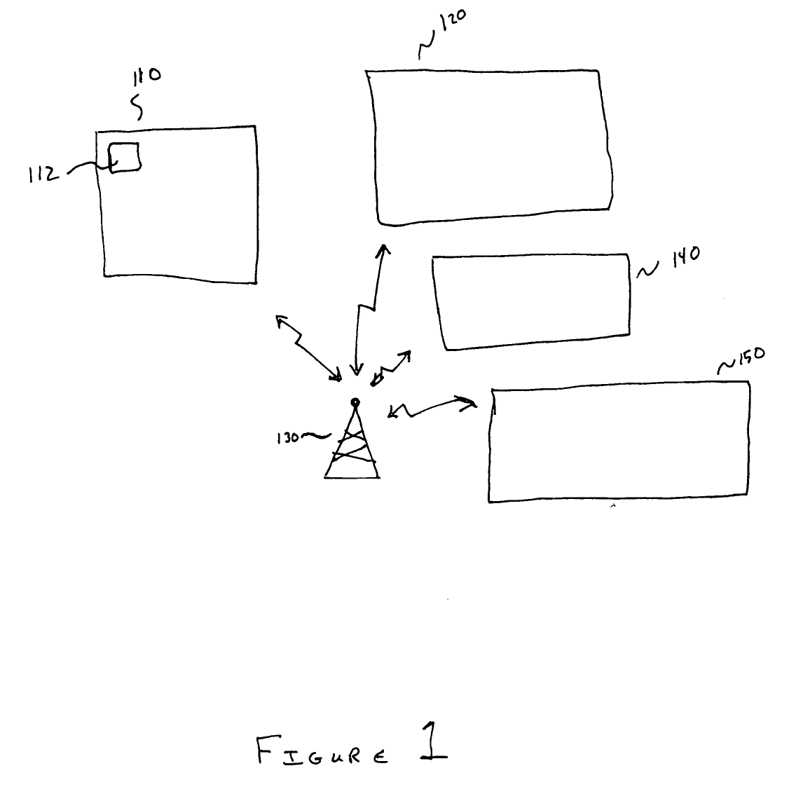

FIG. 1 illustrates a network including several terminals. A resident location based services (LBS) application (LBA) 112 can reside on a mobile terminal, such as a SUPL Enabled Terminal (SET) 110. Although the mobile terminal will be referred to as a SET, other types of mobile terminals are not excluded, and thus a SET is just one example of applicable mobile terminals. The application 112 may need to receive the location information of a second SET 120 (or cluster of several SETs, such as SET 120, Set 130, and SET 140) to provide a service to SET 110.

SET 110 may obtain the location of SET 120 (or the cluster) by communicating with a network via base station 130. The base station 130 may also be in communication with a third SET 140 and a fourth SET 150.

The SUPL architecture discussed may, for example, be as described in the 3GPP2 specification. The network entities involved in providing location based services may be the SUPL Location Client (SLC) and the SUPL Position Client (SPC). The separate cases of period and non-periodic tracking are discussed below.

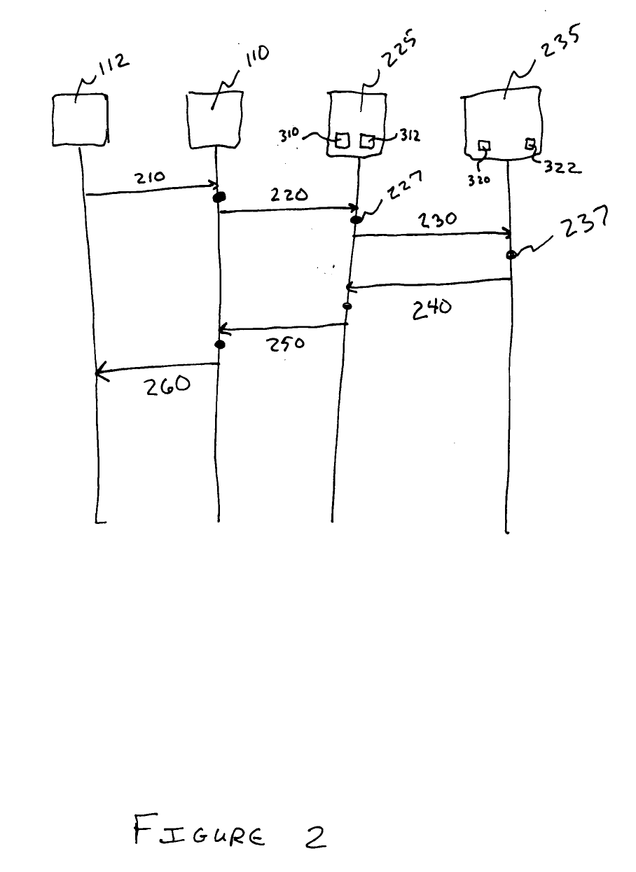

In this section, a signaling framework that may be used to provide the non-periodic location based services signaling is described. SET 110 based LBA 112 uses the following steps to receive the location information of SET 120. FIG. 2 illustrates the high-level messaging sequence.

LBA 112 sends a request 210 to SET 110 requesting location information of SET 120. The LBA 112 includes the identity of SET 120 in the request 210. LBA 112 may also include in the request 210 information that may be used to authenticate and therefore authorize the location request in SET 120's network.

SET 120 can forward 220 the request 210 to the home SLP (or home SLC (H-SLC)) 225 of the SET 120. SLP 225 may possibly contain SLC 310 and SPC 312. It should be noted that the signaling may require contacting the location services nodes in the home network, and decisions that allow this to work can also be made locally in a network in which a SET is currently roaming. The message of the request 210 being forwarded 220 should have information that will authenticate SET 110 and, if needed, the LBA 112 as well as the identity of SET 120 that will be used by the SLP 225 to identify a home network of the home LBS nodes of SET 120. This message may be protected using the trust relationship that exists between SLP 225 and SET 110.

In the case of a cluster, the request 210 may need to include particular information for each member of the cluster. Alternatively, the request 210 may include an identifier that permits SLP 225 to determine the information for each member of the cluster. If different request types are required for different members of the cluster, then this may be specified in the request 210.

Based on the information about SET 120 in the message, SLP 225 identifies the LBS node in the home network of SET 120, namely SLP 235. SLP 235 may possibly contain SUPL Location Center (SLC) 320 and SUPL Position Center (SPC) 322. To acquire the identity of SLP 235, SLP 225 may contact a local domain name server (DNS) or any other entity that is able to translate information contained in SET 110's message to SLP 225 into a format that can be used to contact SET 120's home network. Alternatively, SLC 310 could contact a local cache to identify SLC 320. It should be noted that if SET 120 belongs to the same network as SET 110, then SLC 310 can initiate location based services signaling with SET 120 using any conventional means. In such a case, the next step may be redundant.

Once SET 120's home network node (SLC 320) has been identified, SLC 310 contacts 230 SLC 320 with the location request 210 from SET 110. This message can be transported using any transport protocol (internet protocol (IP)-based or non-IP-based) that for inter-SLP communication. Some of these protocols are described in various versions of the 3GPP2 X.P.0024 IP-LCS specification. This message may be secured using a pre-existing (or freshly derived) trust relationship that exists between the networks to which the SLPs belong.

Once SLC 320 (SLC 310 when SET 120 belongs to SLC 310's network) receives the information about SET 120, as well as the authentication information about SET 110 and possibly the LBA 312 in SET 110, it can verify 237 whether SET 110, and its associated application (LBA 312), is authorized to receive SET 120's location information. If it is determined that SET 110 and its associated application are authorized, then SLC 320 (or SLC 310, when applicable) can proceed to contact SET 120 to determine the location information of SET 120 or otherwise obtains SET 120's location information.

Once SET 120's location information is determined, this information can be forwarded to the SLC 320 or SLC 310 when SET 120 belongs to the same network as SET 110. In such a case, the next step may be redundant.

SLC 320 then forwards 240 SET 120's location information to SLC 310. This message may be protected using the trust relationship that exists between SLC 310 and SLC 320.

SLC 310 transfers 250 SET 120's location information to SET 110. This message may be protected using the trust relationship that exists between SLC 310 and SET 110.

SET 110 can authenticate this message and forwards 260 the location information to the requesting resident application. Using the location information, the application can provide the desired service to the user.

The present invention is directed, according to one embodiment, to a process of initiating services on a first mobile unit based on the location of a second mobile unit is disclosed. An application on the first mobile unit can send a request to first mobile unit requesting the second mobile unit's location information. The first mobile unit can forward this message to its home SLP. Based on information in the message, the home SLP can identify the home network of second mobile unit, namely SLP 235. Once the second mobile unit's home network node (SLC 320) has been identified, SLC 310 contacts SLC 320 with the location request from the first mobile unit. Once SLC 320 receives the information about the second mobile unit, it can verify whether the first mobile unit and its associated application are authorized to receive the second mobile unit's location information. This information can thereafter be forwarded to the SLC 320 and SLC 320 then can forward the second mobile unit's location information to SLC 310. SLC 310 can transfer the second mobile unit's location information to the first mobile unit. The first mobile unit can authenticate this message and forward the location information to the requesting resident application. Using the location information, the application can provide the required service to the user.

It is noted that throughout the above description, when a SLC 320 is needed, SLC 310 contacts the SLC 320 on SET 110's behalf, but this is not mandatory. In an alternative embodiment, the SLC 310 can provide SLC 320's identity to SET 110 using a message that is protected using the trust relationship that exists between SLC 310 and SET 110. SET 110 can then initiate a communication with SLC 320 as described above. In such a case, this message can be protected using some trust relationship (either derived from some other trust relationship or freshly established). Once SLC 320 receives this information, it can again use one of the several mechanisms presented in the specifications for network based location requests to determine the location information of SET 120. SLC 320 then forwards the location information to SET 120.

The transport for the messaging between SET 120 and SLC 320 can be, for example, IP based or short message service (SMS) based. In another embodiment, SET 110 could perform a DNS lookup on its own without contacting its home SLP (SLP 225) to ascertain the identity of SLP 235 (home SLP of SET 120). It could then send the location request to SLP 235 as described previously.

In another embodiment, if SET 110 is roaming in a visited network, SET 110 could contact its visited SLP instead of its home SLP (SLP 225) and the visited SLP could perform the same functions as described as being done by SLP 225 previously. Accordingly, SLP 225 can refer either to the home SLP or the visited SLP. In another embodiment, the visited SLP could perform a lookup for SLP 235's identity and transfer the information back to SET 110, which in turn could contact SLP 235 as before requesting the location information of SET 120.

In another embodiment, if SET 110 knows of a network based application that is authorized to initiate a location information lookup for SET 120, SET 110 can contact this network based application and request a location information lookup. The network application then initiates a network based lookup (once SET 110 is authenticated and determined to be authorized to perform a location lookup) for SET 120. Once SET 120's location information is available at the network based application, it can transfer this information to SET 110.

In another alternative embodiment, SET 110 can contact SET 120 (via, for example, circuit switched or IP based signaling) and request SET 120 to perform a location lookup. SET 120, on the receipt of this message, can authenticate this message and determine whether SET 110 is authorized to request its location information. If SET 110 is authorized, SET 120 then determines the location information. Once SET 120 determines the location information, it transfers this information directly to SET 110. Note, in this case, SLP 225 is not involved and the final information transfer happens between SET 120 and SET 110 (in case of a periodic location request, which is discussed below, at the end of each periodic track SET 120 will have its location information which is then transferred to SET 110).

In another embodiment, SLP 225, upon receiving the request from SET 110, can contact SET 120 directly using, for example, IP or circuit-switched messaging. This message is protected using some trust relationship. On receipt of this message SET 120 determines whether the requesting entity is authorized to request this information. Once this is determined, SET 120 proceeds to determine its location. Once SET 120 ascertains its location, it transfers its information back to SLP 225 or directly to SET 110 (if SET 110's identity is known to SET 120).

The embodiments described above are valid for periodic tracking scenarios also. Some of the signaling messages, however, may have to contain more information for periodic location tracking. Particularly, the location request could contain the inter-tracking time (time between two successive tracks) as well as the total number of tracking sessions (total number location requests). Discussed below is one of the embodiments described above in the context of periodic tracking.

In the periodic case, the LBA 312 also provides information that is necessary for the periodic tracking request. Such information could include the time between location tracks as well as the total number of location tracks and the like. A framework for a mobile station (MS) to periodically track another MS or a cluster of MSs is discussed below.

Once SLC 310 receives the periodic location request, it can use a similar mechanism, as described above, to identify SLC 320. Once SLC 320 has been identified, SLC 310 can initiate a location request at SLC 320. SLC 320 in, for example, a 3GPP2 architecture, can respond to this request in the way it would respond to any network initiated periodic location request of a mobile terminal that belongs the SLC 320's network. Using any of the signaling mechanisms that are currently defined in the 3GPP2 specification, SLC 320 (which may correspond to PS2 in the 3GPP2 specification) retrieves the location information of SET 120. At the end of each track, once the location information is available at SLC 320, SLC 320 forwards the information to SLC 310. SLC 310, in turn, can forward the information to SET 110. SET 110 can forward the information to the SET 110 residing LBA 112, which then offers the service based on this location information.

The mechanism of transferring the location information to the SET 110 from SLC 320 can be similar to the mechanism described previously. It is also to be noted that depending on whether a proxy mode request or a non-proxy mode request is made from SLP 235, for each location tracking session within a periodic session, different network entities can be involved in communicating with SET 120 to determine its location. Whatever the mechanism that is used, at the end of each period, SET 120's location information can be present at SLP 235 ready to be transferred to SET 110 using the signaling described previously. This process can be continued for the requested number of tracks.

It should be noted that although SLC 310 makes the location request to SLC 320, it is possible that SET 110 can make the above request or any of the other embodiments described above could be used by the SET 110 to contact SLP 235. Similarly, the alternative embodiments described above are also valid in the periodic tracking scenarios.

It is also noted that in the embodiments described above, the error signaling has not been explicitly mentioned. It is to be understood that appropriate error messages could be exchanged between the entities involved in case of error. It is also to be understood, that all signaling messages are protected using appropriate trust relationships that exists between communicating entities. The transport for these messages can be circuit-switched or IP based.

In addition, as discussed above, the present invention is also applicable to providing location based applications, residing on the mobile node, based on the locations of more than one mobile node or mobile nodes that that are members of a particular group. In such applications, multiple objects or persons may be tracked through a mobile phone or a service may be initiated at the mobile unit based on a location of a particular member of a predefined group. It is acknowledged that some of the tracking signals would need to be modified to accomplish the present invention by taking into account locations of multiple entities. Additionally, for each of these multiple entities, any of the above-discussed alternate embodiments can be employed. For example, if a user were tracking children at a theme park, with each child having a mobile device, certain children may be tracked periodically, while another may be tracked just once. Further, the mobile devices that are tracked could belong to different operator domains and potentially be distributed across continents.

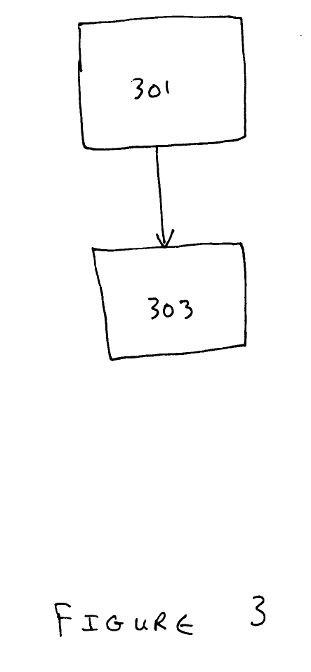

FIG. 3 illustrates one method according to an embodiment of the present invention. The method includes identifying 301 a first node and a second node. This may be done by reviewing a request message from a location based application that is resident on the first node. The identity of the first node and the second node may be ascertained by reading an address provided in the request. The identifying 301 may alternatively be identifying a first node and a cluster. The cluster may include two or more nodes. The nodes may be associated with people, pets, or other objects.

Next, the method may include serving 303 the first node with a service based on a location of the second node. This step may require determining the location of the second node. The determination of the location of the second node may be performed by a database lookup. The database may be in a local cache or may be obtained by communicating with a second or multiple networks. The serving 303 may alternative be serving the first node with a service based on a location of the cluster. The location of the cluster may refer to a centroid of the locations of the members of the cluster, to the location of a nearest member of the cluster, to the location of a most distant member of the cluster, a location of the average distance of the members of the cluster, or an indication of the presence or absence of a member of the cluster (or of a subset up to all of the members of the cluster) within a geographic area. These examples are neither exhaustive nor limiting.

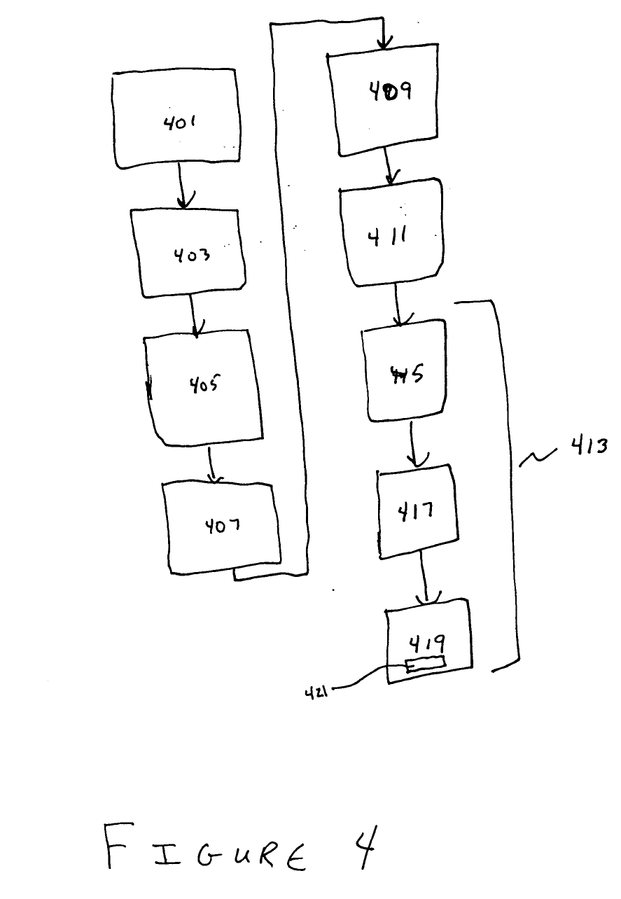

FIG. 4 illustrates another method according to an embodiment of the present invention. According to this embodiment, the method may begin by providing 410 a request from a location based application to a mobile node. The mobile node may forward 403 the request to a location information platform.

The location information platform may identify 405 a second mobile node from the request. The identification of the second mobile node may be performed by locating an address in the request or by obtaining an address based on information such as a pseudonym, group name, or other indirect means.

The location information platform may also identify 405 a second location information platform corresponding to the second mobile node. In some cases the location information platform and the second location information platform may be the same device. In other examples, the location information platform and the second location information platform may be in the same network. In yet other examples, the location information platform and the second location information platform may be in different networks.

The location information platform may contact 407 the second location information platform with the request. When the location information platform and the second location information platform are the same entity, this step may not require the transmission of data.

The second location information platform may then obtain 409 location information regarding the second mobile node. This obtaining of location information may be performed by referencing a local cache containing an on-going track of the second mobile node, may involve initiating a conventional location determination routine, such as multilateration, to determine the location of the second mobile node, or may involve contacting the second mobile and requesting the second mobile node's location information from the second mobile node. These examples of how to obtain the location information are not exhaustive, and other ways of obtaining the location information are permitted.

The second location information platform may provide 413 the location information to the location based application. The provision of the location information may take the form of directly transmitting the location information to the location based application. However, it may be convenient to provide the location information to the location based application in the following way. The second location information platform may forward 415 the location information to the location information platform. The location information platform may then transfer 417 the location information to the mobile node. The mobile node may then forward 419 the location information to the location based information. While processing the forwarding, the mobile node may authenticate 421 the location information. Such an authentication step may be useful to avoid spoofing of the location information by a malicious node.

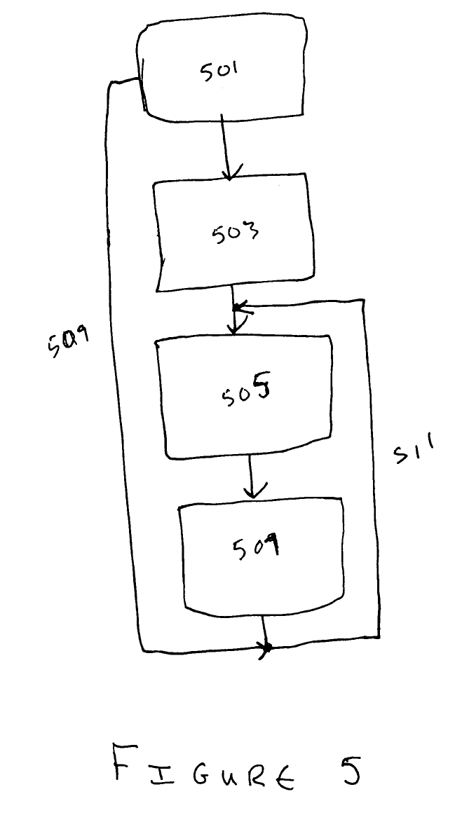

FIG. 5 illustrates yet another method according an embodiment of the present invention. A location information platform may receive 501 a request from a location based application of a mobile node for location information regarding a second mobile node. The location information platform may identify 503 a resource for the location information. The resource may be local to the location information platform or may be remote from the location information platform. The location information platform may obtain 505 the location information from the resource. Obtaining the resource may be performed by reading the location information from a local cache, by requesting the location information from the second mobile node, or by requesting the location information from a second location information platform. These examples of how to obtain 505 the location information are not exhaustive. In obtaining the location information, the location information platform may rely on a trust relationship between the location information platform's home network and a different network. If the mobile node is roaming, the trust relationship may be between the home network of the mobile node and the home network of the location information platform.

The location information platform may subsequently provide 507 the location information to the location based application. Provision of the location information to the mobile node may be mediated by the mobile node.

If the request is periodic 509 or indicates that periodic updates a required, the location information platform may identify the request as such, and may revert 511 to obtain 505 and provide 507 the location information multiple times.

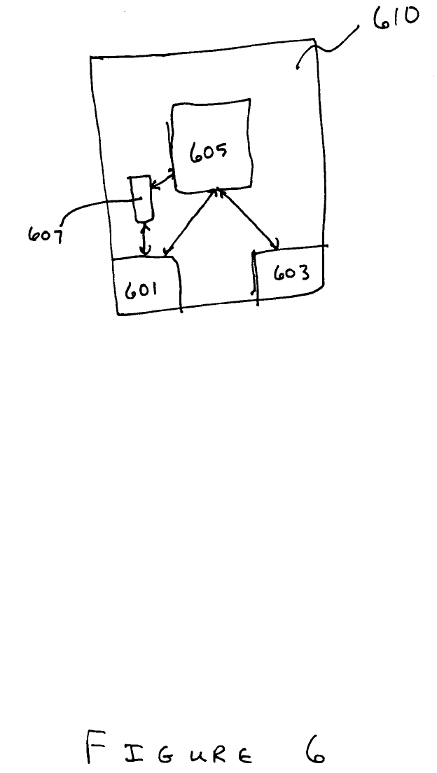

FIG. 6 illustrates a device according one embodiment of the present invention. The device may be a mobile terminal or node 610. The node 610 may be in contact with a wireless network via a base station, like base station 130 in FIG. 1. The node 610 may include a processor 605 such as may be found in a general purpose computer, or a processor such as may be found in a conventional personal digital assistant (PDA) or other portable computer or similar device. The processor 605 may be in a communication and/or control relationship with a location based application 601 and a transceiver 603. The location based application 601 may be implemented in software, hardware, or some hybrid. Additionally, code for the location based application 601 may be stored in a memory 607 of the device. The memory may be a read only memory, a re-writable memory, or any other suitable memory. The memory may be implemented modularly as a memory stick or flash card device.

The transceiver 603 may include an antenna configured to operate in a wireless communication environment as well as various supporting hardware and/or software to assist the antenna in communicating. The term antenna is used broadly to include monopole antennas, patch antennas, and the like as well as other emanating devices such as infrared ports or optical laser ports that may not conventionally thought of as antennas.

The location based application 601 may be configured to request location information regarding a second mobile node a cluster. The cluster may include two or more mobile nodes.

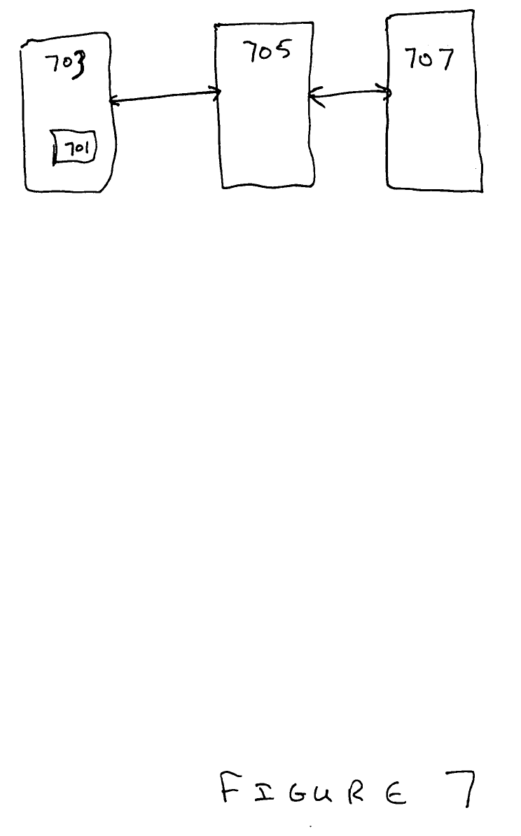

FIG. 7 illustrates a system according to another embodiment of the present invention. The system includes a location based application 701 resident on a mobile node 703. The location based application 701 may configured to provide a request to the mobile node 703. The mobile node 703 may be designed like node 610 in FIG. 6, but this is not a requirement.

The mobile node 703 may configured to receive the request and forward the request to a location information platform 705. The location information platform 705 may be a SUPL Location Platform as described by the Open Mobile Alliance (OMA), or may be a similar element. The location information platform 705 may include a processor for processing information, a memory for storing information, and a transceiver for communicating information. The location information platform 705 may be part of a same network with the mobile node 703 (in which case it may be a Home (H-SLP) as described by OMA) or it may be part of a network in which the mobile node 703 is roaming (in which case it may be a Visited SLP (V-SLP) as described by OMA).

The location information platform 705 may be configured to receive the request from the mobile node 703, to identify a second mobile node from information in the request, to identify a second location information platform 707 corresponding to the second mobile node, and to contact the second location information platform 707 with the request. In the event that identifying the second location information platform 707 corresponding to the second mobile node yields the result that the second location information platform 707 and location information platform 705 are the same entity, the contact of the second location information platform 707 may take the form of internally identifying as opposed to any form of external transmission.

The second location information platform 707 may be of similar construction to the location information platform 705, though this is not required. The second location information platform 707 may be configured to obtain location information regarding the second mobile node based on the request. The second location information platform 707 may be configured to obtain the location information from a track stored locally or elsewhere in a network. The second location information platform 707 may also be configured to contact the second mobile node to obtain the location information.

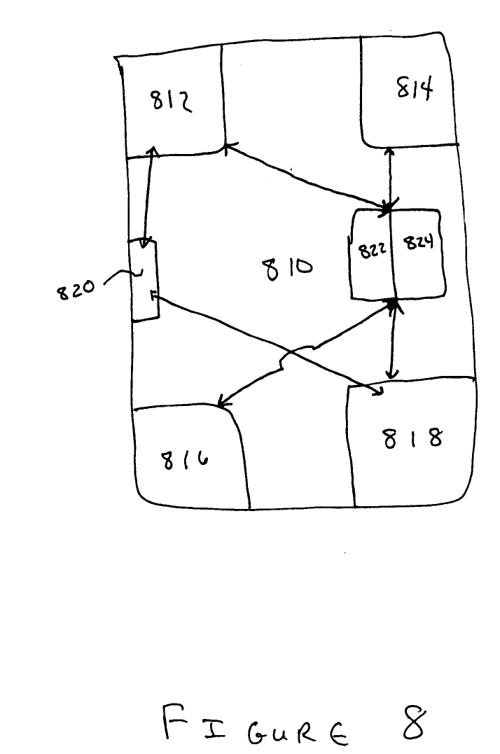

FIG. 8 illustrates a device according to another example of the present invention. The device may be a location information platform 810. The location information platform 810 may constructed similarly to location information platform 705 or location information platform 707 in FIG. 7, though this is not a requirement. The location information platform 810 may include various units. One unit may be a receiver unit 812 configured to receive a request from a location based application of a mobile node for location information regarding a second mobile node or a cluster of mobile nodes.

The location information platform 810 may also include an identification unit 814 configured to identify a resource (either the location information platform 810 itself, a database, or another network entity) for the location information requested by the location based application. The identification of the resource may involve identifying a network (or networks) with which the second mobile node or cluster is associated, and identifying a second location information platform corresponding to that second mobile node, cluster, or network(s).

The location information platform 810 may also include an obtainer unit 816. The obtainer unit 816 may operate in dependence on the identification unit 814. The obtainer unit 816 may be configured to obtain the location information from the resource.

The location information platform 810 may further include a provision unit 818. The provision unit 818 may be configured to provide the location information obtained by the obtainer unit 816 to the location based application. The provision unit 818 may rely on a communication unit 820 that it may share with the receiver unit 812. The communication unit 820 may include standard communication hardware and/or software including an antenna and/or network card.

Each of the units (812, 814, 816, and 818) may share a processor 822 and a common memory 824. Alternatively, each unit may have its own processor and memory (not shown).

Another embodiment of the present invention is a device including application means for running a location based application. The device also includes communication means for obtaining a location of a mobile node for the application means.

Another embodiment of the present invention is a system including application means for providing a request. The system also includes mobile means for receiving the request from the application means, and forwarding the request. The system further includes platform means for receiving the request from the mobile means, identifying a mobile terminal from the request, identifying a second platform means corresponding to the mobile node, and to contact the second platform means with the request. The system additionally includes the second platform means for receiving the request, obtaining location information of the second mobile node, and providing the location information to the location based application.

A further embodiment of the present invention is a device including receiver means for receiving a request from a location based application of a mobile node for location information regarding a second mobile node. The device also includes identification means for identifying a resource for the location information. The device further includes obtainer means for obtaining the location information from the resource. The device additionally includes provision means for providing the location information to the location based application.

Another embodiment of the present invention is a device including identification means for identifying a first node and a cluster. The device also includes service means for serving the first node with a service based on a location of a portion of the cluster.

An additional embodiment of the present invention is a computer program embodied on a computer-readable medium configured to perform receiving a request from a location based application of a mobile node for location information regarding a second mobile node. The program is also configured to perform identifying a resource for the location information. The program is further configured to perform obtaining the location information from the resource. The computer is additionally configured to perform providing the location information to the location based application.

Even though the invention has been described above with reference to several examples according to the accompanying drawing, it is clear that the invention is not restricted thereto but it can be modified in several ways within the scope of the overall disclosure.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A method, comprising:
identifying a first node and an entity; and
serving the first node with a service based on a location of the entity,
wherein the method is implemented by a location based application residing on a the first node, and wherein the entity is configured to be a mobile entity.

2. The method of claim 1, wherein the serving the first node comprises providing at least one of a gaming experience to the first node, or a location of the second node to the first node.

3. The method of claim 1, wherein the providing the location of the second entity comprises providing the location of at least one of a second mobile node, a cluster, a pet, a vehicle, an employee, a coworker, a friend, or a family member.

4. The method of claim 1, wherein the serving the first node comprises operating a location based application based on the location of the entity.

5. A method, comprising:
providing a request from a location based application to a mobile node;
forwarding, by the mobile node, the request to a location information platform;
identifying, by the location information platform, a second mobile node from the request;
identifying, by the location information platform, a second location information platform corresponding to the second mobile node;
contacting, by the location information platform, the second location information platform with the request;
obtaining, by the second location information platform location information of the second mobile node; and
providing the location information to the location based application.

6. The method of claim 5, wherein the providing the request comprises providing at least one of an identity of the second mobile node, or authentication information.

7. The method of claim 6, wherein the providing the authentication information comprises providing information for at least one of the location based application or the mobile node.

8. The method of claim 5, further comprising:
configuring the location information platform to also be the second location information platform.

9. The method of claim 5, wherein the identifying the second location information platform comprises contacting at least one of a local domain name server, or a local cache.

10. The method of claim 5, further comprising:
securing the contacting the second location information platform using a trust relationship between a network of the location information platform and a network of the second location information platform.

11. The method of claim 5, wherein the providing the location information comprises
forwarding the location information from the second location information platform to the location information platform,
transferring the location information from the location information platform to the mobile node, and
forwarding the location information from the mobile to the location based application.

12. The method of claim 11, further comprising:
authenticating, by the mobile node, a message containing the location information before forwarding the location information to the location based application.

13. A method, comprising:
receiving a request from a location based application of a mobile node for location information regarding a second mobile node;
identifying a resource for the location information;
obtaining the location information from the resource; and
providing the location information to the location based application.

14. The method of claim 13, further comprising:
performing the obtaining and providing periodically.

15. The method of claim 15, wherein the performing the obtaining and providing periodically is responsive to the receiving the request periodically.

16. The method of claim 13, wherein obtaining the location information comprises obtaining the location information directly or indirectly from the second mobile node.

17. A device, comprising:
a location based application resident on the device; and
a transceiver configured to obtain a location of an entity to activate the location based application,
wherein the device is configured to be mobile, and
wherein the entity is configured to be a mobile node or a cluster.

18. The device of claim 17, wherein the location based application comprises at least one of a multi-player game, or a display of the location of the mobile node.

19. The device of claim 17, wherein the location based application is configured to provide the location of at least one of a pet, a vehicle, an employee, a coworker, a friend, or a family member.

20. The device of claim 17, wherein the device is a mobile terminal.

21. A system, comprising:
a location based application configured to provide a request to a mobile terminal;
the mobile terminal configured to receive the request, and forward the request to an location information platform;
the location information platform configured to receive the request from the mobile terminal, to identify a second mobile terminal from the request, to identify a second location information platform corresponding to the second mobile node, and to contact the second location information platform with the request;
the second location information platform configured to receive the request, obtain location information of the second mobile node, and provide the location information to the location based application.

22. The system of claim 21, wherein the request comprises at least one of an identity of the second mobile node, or authentication information.

23. The system of claim 22, wherein the authentication information comprises information for at least one of the location based application or the mobile node.

24. The system of claim 21, wherein the location information platform is also the second location information platform.

25. The system of claim 21, wherein the location information platform is configured to identify the second location information platform by contacting at least one of a local domain name server or a local cache.

26. The system of claim 21, wherein the location information platform is configured to contact the second location information platform using a trust relationship between a network of the location information platform and a network of the second location information platform.

27. The system of claim 21, wherein the second location information platform is configured to provide the location information by forwarding the location information to the location information platform, wherein the location information platform is configured to transfer the location information to the mobile node, and wherein the mobile node is configured to forward the location information to the location based application.

28. The system of claim 27, wherein the mobile node is configured to authenticate a message containing the location information before forwarding the location information to the location based application.

29. A device, comprising:
a receiver unit configured to receive a request from a location based application of a mobile node for location information regarding a second mobile node;
an identification unit configured to identify a resource for the location information;
an obtainer unit configured to obtain the location information from the resource; and
a provision unit configured to provide the location information to the location based application.

30. The device of claim 29, wherein the obtainer unit and provision unit are configured to operate periodically.

31. The device of claim 29, wherein the obtainer unit and provider unit are configured to operate periodically in response to the receiver unit receiving the request periodically.

32. The device of claim 29, wherein obtainer unit is configured to obtain the location information directly or indirectly from the second mobile node.
